(19) United States
(12) Patent Application Publication
(10) Pub. No.: US 2014/0270907 A1
(43) Pub. Date: Sep. 18, 2014

(54) Connecting Element

(71) Applicant: Bayerische Motoren Werke Aktiengesellschaft, Muenchen (DE)

(72) Inventor: Johann van NIEKERK, Muenchen (DE)

(73) Assignee: Bayerische Motoren Werke Aktiengesellschaft, Muenchen (DE)

(21) Appl. No.: 14/352,941

(22) Filed: Apr. 18, 2014

Related U.S. Application Data
(63) Continuation of application No. PCT/EP2012/072134, filed on Nov. 8, 2012.

(30) Foreign Application Priority Data
Dec. 22, 2011 (DE) 102011089519.1

(51) Int. Cl. F16C 11/06

(52) U.S. Cl. CPC F16C 11/06
USPC 403/77; 403/76

(57) ABSTRACT

A connecting element for connecting two components includes a socket part provided for connecting to a first component, into which socket part is inserted a spherical element. From the spherical element, a function element projects which is provided for connecting to a second component.

### CROSS REFERENCE TO RELATED APPLICATIONS

This application is a continuation of PCT International Application No. PCT/EP2012/072134, filed Nov. 8, 2012, which claims priority under 35 U.S.C. §119 from German Patent Application No. 10 2011 089 519.1, filed Dec. 22, 2011, the entire disclosures of which are herein expressly incorporated by reference.

### BACKGROUND AND SUMMARY OF THE INVENTION

The present invention relates to a connecting element for connecting two components, as well as to a component connection formed with the connecting element.

It is an object of the invention to create a versatile connecting element for connecting two components, which, to a certain extent, can also compensate tolerances that may occur during the positioning of the components to be mutually connected.

This and other objects are achieved by a connecting element for connecting two components, having a socket part provided for connecting with a first component, into which socket part a spherical element is inserted, wherein a functional element, which is provided for connecting with a second component, projects from the spherical element.

The invention is based on the idea of creating a connecting element that is similar to a “ball-and-socket joint”. A connecting element according to the invention has a “socket part” which is similar to a socket of a ball-and-socket joint and which is to be connected with a first component, and a “spherical element” which is inserted into the socket part and can be swiveled in the socket part. A “functional element”, which is provided for the connection with a second component, projects from the spherical element. In a manner comparable with a ball-and-socket joint, the spherical element and the functional element projecting therefrom are swivelably arranged with respect to the socket part.

By way of the swiveling of the spherical element and of the functional element connected therewith, tolerances, which may occur during the relative positioning of the two components to be connected with one another, can be “compensated” to a limited extent.

The term “spherical element” should be interpreted broadly. The spherical element does not necessarily have to be a solid ball. It may also be a universal ball joint or a shape which deviates completely from a spherical shape and which permits a swiveling of the spherical element in or relative to the socket part.

According to a further aspect of the invention, the functional element has a thread for a screwed connection with the second component. The functional element may, for example, be designed as a threaded pin, i.e. as a pin-type section having an external thread. However, in principle, an internal thread could also be provided in the functional element, into which internal thread, for example, a screw could be screwed, by which the functional element is connected with the second component.

As an alternative, the functional element may also be designed as a nut-type element having an internal thread.

The circumference of the functional element may also be designed as a “polygon”, such as comparable to or identical with the “polygon” of conventioned screw nuts.

The invention particularly also includes a component connection per se, in the case of which the socket part of the above-described connecting element is inserted into a passage hole or into a depression, indentation or the like, of the first component or is connected with the first component in another manner. The socket part may be provided with an edge or a projection which overlaps the passage hole, the indentation, the depression, etc.

It may further be provided that the socket part, or more precisely, the outside contour of the socket part, or a portion of the outside contour of the socket part, is form-fittingly locked with the first component. For this purpose, at least one detent element may be provided on an exterior side of the socket part, which detent element reaches behind the passage hole on a side of the first component facing away from the edge or the edge section.

The socket part may additionally be glued to the first component.

The socket part may, for example, be made of metal, particularly of steel or aluminum. As an alternative, it may also be made of a plastic material.

Likewise, the functional element and/or the spherical element may be made of metal, particularly of steel or aluminum. As an alternative, the functional element and/or the spherical element may also be made of a plastic material.

The invention can be used extremely broadly. One or both components to be connected with one another may, for example, be vehicle parts, particularly body parts of a vehicle. One or both components to be connected with one another may entirely or partially consist of plastic material, particularly of a fiber-reinforced plastic material.

The invention is particularly suitable for so-called “composite applications”, i.e. applications in which components of different materials are to be mutually connected by way of a connecting element. Such composite applications can increasingly be found in the automotive industry. This concerns, for example, the connection of a first component consisting of metal (for example, steel or aluminum) with a plastic component (for example, a fiber-reinforced plastic component). Connecting elements according to the invention are excellently suitable for this purpose.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1 is a view of a first embodiment according to the invention;

FIG. 2 is a view of the first embodiment of FIG. 1 with an edge section of the socket part;

FIGS. 3 and 4 are views of a second and a third embodiment, respectively, according to the invention; and

FIGS. 5 and 6 are side and top views, respectively, of a fourth embodiment according to the invention.

### DETAILED DESCRIPTION OF THE DRAWINGS

FIGS. 1 and 2 illustrate a first embodiment of a connecting element 1 which has a socket part 2 into which a spherical element 3 is inserted. A pin 5, provided with an external thread 4, projects from the spherical element 3. The pin 5 is used as a functional element, which is provided for the connection with a second component (not shown here). The spherical element 3 and the pin 5 projecting therefrom can be swiveled relative to or in the socket part 2. In the embodiment illustrated in FIGS. 1 and 2, the socket part 2 is inserted into a recess 7, which is provided in a first component 6 and is a passage hole here. The socket part 2 may be additionally glued to the first component 6.

In the variant illustrated in FIG. 2, the socket part 2 has an edge or edge section 8, which extends over the hole 7, i.e. projects over the edge of the hole 7. The edge or edge section 8 therefore overlaps the passage hole 7.

A detent element (not shown) could additionally be provided on a side of the first component 6 on an exterior side of the socket part 2, which side faces away from the edge or edge section 8, by way of which detent element the socket part 2 can be locked in a form-fitting manner with the first component 6.

FIGS. 3 and 4 illustrate further embodiments according to the invention. In the embodiment according to FIG. 3, the connecting element 1 is designed as a ring 5a instead of a pin.

In the embodiment of FIG. 4, the functional element is designed as a nut 5b, which has an internal thread.

The embodiments of FIGS. 5 and 6 illustrate a connecting element 1 having two socket parts 2a, 2b, which are each inserted into a respective hole 7a, 7b provided in the first component 6. Although the connecting element 1 has two socket parts 2a, 2b, it has only one functional element 5c, which mutually connects the two socket parts 2a, 2b. As illustrated best in FIG. 6, the functional element is designed here as a nut 5c having an internal thread. In contrast to the embodiment of FIG. 4, the nut 5c is arranged such that the longitudinal or thread axis of the nut 5c extends in a direction which is essentially perpendicular to a surface of the first component 6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A connecting element for connecting two components, comprising:
a socket part configured for connecting with a first of the two components;
a spherical element configured to be inserted into the socket part;
a functional element configured for connecting with a second of the two components, wherein
the functional element projects from the spherical element.

2. The connecting element according to claim 1, wherein the spherical element and the functional element projecting therefrom are adapted to be swiveled with respect to the socket part.

3. The connecting element according to claim 1, wherein the functional element comprises a threaded area configured for a screwed connection with the second component.

4. The connecting element according to claim 2, wherein the functional element comprises a threaded area configured for a screwed connection with the second component.

5. The connecting element according to claim 3, wherein the functional element comprises a threaded pin having a thread for the screwed connection with the second component.

6. The connecting element according to claim 1, wherein the functional element comprises a nut-type element having an internal thread.

7. The connecting element according to claim 2, wherein the functional element comprises a nut-type element having an internal thread.

8. The connecting element according to claim 3, wherein the functional element comprises a nut-type element having an internal thread.

9. A component connection, comprising:
a first component having a passage hole formed therein;
a second component;
a connecting element that connects the first and second components, wherein the connecting element comprises a socket part arranged in the passage hole of the first component; and
the connecting element comprises a spherical element inserted into the socket part, wherein a functional element projects from the spherical element and connects with the second component.

10. The component connection according to claim 9, wherein the socket part comprises an edge configured to overlap a perimeter of the passage hole in the first component.

11. The component connection according to claim 10, wherein the socket part is form fittingly locked to the first component.

12. The component connection according to claim 11, wherein the socket part comprises at least one detent element provided on an exterior side of the socket part, the at least one detent element reaching behind the passage hole on a side of the first component that faces away from the edge of the socket part overlapping the perimeter of the passage hole.

13. The component connection according to claim 9, wherein the socket part has a glued formed fitting connection to the first component.

14. The component connection according to claim 12, wherein the socket part has a glued formed fitting connection to the first component.

15. The component connection according to claim 9, wherein the socket part has a glued connection to the first component.

16. The component connection according to claim 9, wherein the socket part consists essentially of steel, aluminum or a plastic material.

17. The component connection according to claim 16, wherein the functional element and/or the spherical element consists essentially of a steel, aluminum or plastic material.

18. The component connection according to claim 9, wherein the functional element and/or the spherical element consists essentially of a steel, aluminum or plastic material.
